(19) United States
(12) Patent Application Publication
(10) Pub. No.: US 2021/0383175 A1
(43) Pub. Date: Dec. 9, 2021

(54) ADAPTIVE INVERSION METHOD OF INTERNET-OF-THINGS ENVIRONMENTAL PARAMETERS BASED ON RFID MULTI-FEATURE FUSION SENSING MODEL

(71) Applicant: WUHAN UNIVERSITY, Hubei (CN)

(72) Inventors: Guolong SHI, Hubei (CN); Liulu HE, Hubei (CN); Yigang HE, Hubei (CN); Chaolong ZHANG, Hubei (CN); Bolun DU, Hubei (CN)

(73) Assignee: WUHAN UNIVERSITY, Hubei (CN)

(21) Appl. No.: 17/161,690

(22) Filed: Jan. 29, 2021

(30) Foreign Application Priority Data
Jun. 8, 2020 (CN) 202010513430.9

(51) Int. Cl. G06K 9/62; G16Y 20/10; G16Y 30/00

(52) U.S. Cl. CPC G06K 9/6288; G16Y 30/00; G16Y 20/10; G06K 9/6232

(57) ABSTRACT

The disclosure provides an adaptive inversion method of Internet-of-things environmental parameters based on an RFID multi-feature fusion sensing model, including the following steps. Space-medium-interference is proposed as an overall concept, from the multipath propagation mechanism of electromagnetic waves, the electromagnetic wave transmission mechanism is considered. Combining with the joint characteristics of the generalized time domain, frequency domain, energy domain, and spatial domain, a global signal transfer function of RFID sensing is analyzed and derived to complete extraction of RFID sensing main features. A multi-feature fusion sensing model is established, an algebraic relationship between multi-feature fusion parameters and an experimental result is used to give an error functional between a measured data and a forward simulation data, and newly-added sensing information is applied to an environment spatio-temporal changeable adaptive element iteration to form an Internet-of-things environmental parameter adaptive inversion and provide a basis for deployment of RFID in complex Internet-of-things scenes.

### CROSS-REFERENCE TO RELATED APPLICATION

This application claims the priority benefit of China application serial no. 202010513430.9, filed on Jun. 8, 2020. The entirety of the above-mentioned patent application is hereby incorporated by reference herein and made a part of this specification.

### BACKGROUND

### Technical Field

The disclosure relates to the technical field of the Internet of things, and in particular, to an adaptive inversion method of Internet-of-things environmental parameters based on an RFID multi-feature fusion sensing model.

### Description of Related Art

The Internet of things connects sensing devices through multiple access methods to complete information exchange, realizes intelligent monitoring, control, identification, positioning, tracking, etc., covers the entire process of information collection, network transmission, data storage, data analysis, and intelligent applications, and involves key technologies such as sense identification, wireless communication, data storage, cloud computing, nano technology, and intelligent applications. Radio frequency identification (RFID) is one of the key technologies in the sensing layer of the Internet of things, and the sensing efficiency of RFID directly affects the information exchange quality of the sensing layer.

When RFID sensing has spatio-temporal, dynamic, and relevance characteristics, the detection effect of its bottom-layer event will directly determine the definition, detection, and management of higher-layer complex events. For Internet-of-things scenes in which the propagation environment is complex and irregularly shaped, such as dense office spaces, warehouses, subways, shopping malls, etc., studying RFID sensing characteristics can effectively earn time for upper-layer applications of the Internet of things, improve the sensing, cognition, and decision-making frameworks of the Internet of things, enhance the quality of information exchange and user experience, and promote sufficient fusion of “human-machine-things”.

Modeling and simulation of the spatial characteristics, the medium, the electromagnetic interference, and the small-scale fading in a complex Internet-of-things scene provide theoretical guidance and key technical support for the development of the sensing layer. The existing research on the RFID sensing model in specific environments is scattered, the factors are single-faceted, there is a lack of multi-dimensional systematic research on basic consensus factors such as space, multipath, medium, and interference, an inversion of an RFID multi-feature fusion sensing model and Internet-of-things environmental parameters is not formed, and research on adaptive element iteration in the sensing process is still lacking.

### SUMMARY

The disclosure addresses the technical problem that the existing research on the RFID sensing model is scattered, the factors are single-faceted, and there is a lack of multi-dimensional systematic research, and provides an adaptive inversion method of Internet-of-things environmental parameters based on an RFID multi-feature fusion sensing model.

The technical solutions adopted by the disclosure to solve the technical problems herein are as follows.

The disclosure provides an adaptive inversion method of Internet-of-things environmental parameters based on an RFID multi-feature fusion sensing model. The method includes a consensus factor acquisition, a multi-feature fusion sensing model establishment, an Internet-of-things environmental parameter inversion, and an adaptive element iteration. The consensus factor acquisition acquires consensus factors in an Internet-of-things environment including a spatial geometry, a multipath effect, a medium, an electromagnetic interference, a small-scale fading, and an environmental parameter. The multi-feature fusion sensing model establishment models a multi-feature fusion sensing model for an RFID sensing process by analyzing the consensus factors, includes a modeling simulation, a ray tracing, a time-frequency testing, and a channel model establishment, and combined with an electromagnetic wave transmission mechanism and multi-feature fusion parameters, derives and obtains a global signal transfer function of electromagnetic waves when transmitted through various paths. The multi-feature fusion parameters include a time domain feature, an energy domain feature, a frequency domain feature, and a spatial domain feature. The Internet-of-things environmental parameter inversion applies newly-added RFID sensing information to an environment spatio-temporal changeable adaptive element iteration method to form the Internet-of-things environmental parameter inversion. The Internet-of-things environmental parameters include a density parameter, a geometry parameter, an attenuation parameter, and a radiation parameter. The adaptive element iteration derives an error functional between a sensing measured data and a forward simulation data, gives relevant macro statistical performance function and cost function, determines an objective function of an evaluation model, solves a minimization problem of the error functional by iteration using a generalized nonlinear method, inversely deduces a target state parameter to obtain an Internet-of-things environmental parameter component, and forms a closed-loop environmental parameter evaluation. It is determined whether the established model has a standard solution, and if not, the model is modified through further abstraction to transform it into a standard model, or a standard model solution is modified.

Further, the consensus factors in the method of the disclosure specifically include the spatial geometry, the multipath effect, the medium, the electromagnetic interference, the small-scale fading, and the environmental parameter. The spatial geometry is configured to reveal an effect of a spatial location and mobility on path loss. The multipath effect includes direct radiation, refraction, diffraction, and scattering of electromagnetic waves. The medium studies an effect of a multi-media environment on a sensing performance of an RFID tag. The electromagnetic interference includes a frequency offset and a mutual coupling effect caused by an external electromagnetic wave interference and dense tags, and extracts multi-source electromagnetic interference parameter features by using actual RFID sensing performance testing data to reduce collision and conflict between internal readers in a large-scale RFID deployment and improve a precision of location sensing. In the small-scale fading, mutual interference of different multipath components of a wireless signal leads to a change in the small-scale fading of an amplitude of a composite signal, and in a short-distance spatial domain or a short-period time domain, instantaneous values in an amplitude, a phase, and a delay of a received signal show rapid change features. The environmental parameter includes a temperature, a humidity, a radiation, and a pressure.

Further, the modeling simulation in the method of the disclosure specifically includes modeling and measuring a dynamic scene, defining different electromagnetic wave paths in a geometric feature model, configuring reasonable physical model parameters for different paths, and constructing an equivalent physical model.

Further, the ray tracing in the method of the disclosure specifically includes considering an effect of direct radiation, refraction, diffraction, scattering, absorption, and polarization on electromagnetic waves, optimizing a wireless sensing path of a radio frequency tag, and performing accuracy analysis on information of each path to a receiving point. A received signal is represented as:

$$r ( t ) = {\sum }_{i = 1}^{N} {α}_{i} s ( t - {τ}_{i} ) {e}^{j {ϕ}_{i}} ,$$

where s(t) is an emitted ray signal, αᵢ, τᵢ, and ϕᵢ respectively represent an amplitude, an arrival time, and a phase of an i^{th} ray. A signal transfer function G(f, d) at the time when an electromagnetic wave is transmitted through various paths is described as:

$$G ( f , d ) = \frac{λ}{4 π {d}_{d d}} exp ( - j k {d}_{d d} ) + \frac{λ}{4 π {d}_{d r}} {C}_{r} exp ( - j k {d}_{d r} ) + {G}_{3} ( f , {d}_{da} ) + {G}_{4} ( f , {d}_{s} )$$

where d_{dd}, d_{dr}, d_{da}, and dₛ are respectively propagation distances of direct radiation, reflection, diffraction, and scattering paths, λ represents a wavelength, k represents a number of paths, Cᵣ represents a reflection coefficient of a surface of a medium, and G₃(f, d_{da}) and G₄(f, dₛ) respectively represent transfer functions of the diffraction and scattering paths.

Further, the time-frequency testing in the method of the disclosure specifically includes considering time-frequency joint statistical characteristics of an RFID electromagnetic signal, modeling and measuring a dynamic scene, sufficiently considering multiple parameters including propagation characteristics, an antenna type, and an actual scene, analyzing a radiation efficiency, an antenna gain, and a characteristic mode of a tag antenna, and obtaining a raw level sample data set of electromagnetic signals by transforming radio frequency data of a bottom-layer polar coordinate system. The channel model derives and improves small-scale fading models including pure Doppler, Rayleigh, Rician, flat, Nakagami, lognormal, and Suzuki, and meanwhile, considers a complex scattering mechanism and models fading signals superimposed at a receiving end by multipath components of different amplitudes, phases, and delays. Based on assumptions, a mathematical model is used to approximate wireless channel characteristics, and a tag position, a spatial domain direction, a frequency, a bandwidth, and a power parameter are respectively optimized by improved methods.

Further, the global signal transfer function in the method of the disclosure specifically includes determining key parameters of a system channel statistical model and a link budget model in an RFID sensing process, optimizing a sensing model modeling method, deducing a global signal transfer function and an energy loss model of electromagnetic waves in a complex Internet-of-things environment, enhancing a complex event processing capacity in a multi-context sensing environment, and analyzing in depth internal relevance of RFID sensing impact factors in a complex Internet-of-things scene.

Further, in the Internet-of-things environmental parameter inversion in the method of the disclosure, the Internet-of-things environmental parameter inversion includes a density parameter, a geometry parameter, an attenuation parameter, and a radiation parameter, and the Internet-of-things environmental parameter inversion is regarded as a nonlinear least squares problem in the following form:

$$min f ( x ) = \frac{1}{2} {s}^{T} ( x ) s ( x ) = \frac{1}{2} {\sum }_{i = 1}^{m} {[ {s}_{i} ( x ) ]}^{2}$$

$$x ∈ {S}^{n} , m \geq n$$

where f(x) represents an objective function, sᵢ(x) is a residual function representing a difference between a radio frequency sensing measurement data and a forward model calculation data, x is an Internet-of-things environmental parameter to be inverted, n is a number of environmental parameters, and m is a number of extracted sensing feature parameters, and a diagonal ratio matrix is introduced into density, radiation, attenuation, and geometry parameters in inconsistent units to perform coordinate conversion, so that a singular value decomposition result is irrelevant to units.

Further, the adaptive element iteration in the method of the disclosure specifically includes combining an actual testing and an evaluation result to improve and perfect an extraction method, a theoretical model, and an evaluation method of Internet-of-things environmental sensing parameters.

Further, the adaptive element iteration in the method of the disclosure specifically includes initializing parameters of the multi-feature fusion sensing model, and performing calculation and determination based on a least mean square error estimator min E(xₖ−\hat{x}ₖ)(xₖ−\hat{x}ₖ)^{H} by a measurement equation yₖ=h(xₖ)+μₖ and a global transfer function to form an inversion of an Internet-of-things environmental parameter xᵢ=[ρ, γ, δ, ξ]ᵢ, where ρ, γ, δ, and ξ respectively represent the density parameter, the geometry parameter, the attenuation parameter, and the radiation parameter.

Further, in the adaptive element iteration in the method of the disclosure, when an environmental parameter inversion data model is known but there is an error, the inversion parameter completes one adaptive element iteration through a state equation xₖ=f(xₖ₋₁)+ηₖ, a z transformation, an objective function f(x), and the multi-feature fusion sensing model, and combining with the multi-feature fusion sensing model, a measurement data is constantly updated.

The beneficial effects produced by the disclosure are as follows. The adaptive inversion method of Internet-of-things environmental parameters based on an RFID multi-feature fusion sensing model of the disclosure proposes space-medium-interference as an overall concept, sufficiently considers the electromagnetic wave transmission mechanism, combines with the joint characteristics of the generalized time domain, frequency domain, energy domain, and spatial domain, and completes the extraction of the RFID sensing main features. On the basis of theoretical research, combined with actual measurement verification, the establishment of the RFID multi-feature fusion sensing model in a complex Internet-of-things environment is realized. Centered around the complex Internet-of-things environment RFID sensing model, inversions of environmental parameters, complexity levels, and data perturbation of different Internet-of-things scenes are formed. Multipath electromagnetic wave sensing paths are optimized to provide a basis for deployment of RFID in complex Internet-of-things scenes and efficiently obtain key information such as states and locations to achieve sufficient fusion of “human-machine-things”. Lastly, a new method of environmental Internet-of-things parameter inversion based on a multi-feature fusion sensing model is established.

### BRIEF DESCRIPTION OF THE DRAWINGS

The disclosure will be further described below with reference to the accompanying drawings and embodiments.

FIG. 1 is a flowchart of an adaptive inversion method of Internet-of-things environmental parameters based on an RFID multi-feature fusion sensing model according to an embodiment of the disclosure.

FIG. 2 is an environmental parameter inversion data model of an embodiment of the disclosure.

### DESCRIPTION OF THE EMBODIMENTS

To make the objectives, technical solutions, and advantages of the disclosure more apparent, the disclosure will be described in further detail below with reference to the accompanying drawings and embodiments. It should be understood that the specific embodiments described herein are merely illustrative of the disclosure and are not intended to limit the disclosure.

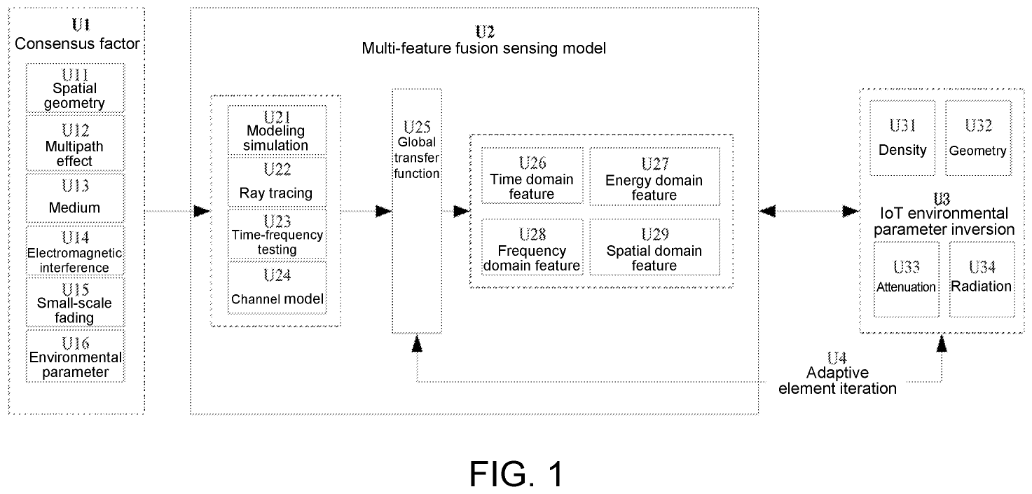

As shown in FIG. 1, an adaptive inversion method of Internet-of-things environmental parameters based on an RFID multi-feature fusion sensing model of an embodiment of the disclosure includes a consensus factor U1, a multi-feature fusion sensing model U2, an Internet-of-things environmental parameter inversion U3, and an adaptive element iteration U4.

The consensus factor U1 covers a spatial geometry U11, a multipath effect U12, a medium U13, an electromagnetic interference U14, a small-scale fading U15, and an environmental parameter U16. By analyzing the effect of the spatial geometry U11, the multipath effect U12, the medium U13, the electromagnetic interference U14, the small-scale fading U15, and the environmental parameter U16 on a sensing process of a radio frequency tag, sensing parameters including a working frequency, a received power, a radiant power, a ray path, a delay spread, and a path loss are studied.

The spatial geometry U11 is intended to reveal the effect of a spatial location and mobility on path loss. The multipath effect U12 includes direct radiation, refraction, diffraction, and scattering of electromagnetic waves. The medium U13 studies the effect of a multi-media environment on the sensing performance of an RFID tag. The electromagnetic interference U14 includes a frequency offset and a mutual coupling effect caused by an external electromagnetic wave interference and dense tags, and extracts multi-source electromagnetic interference parameter features by using actual RFID sensing performance testing data to reduce collision and conflict between internal readers in a large-scale RFID deployment and improve the precision of location sensing. Mutual interference of different multipath components of a wireless signal leads to a change in the small-scale fading U15 of an amplitude of a composite signal, and in a short-distance spatial domain or a short-period time domain, instantaneous values in an amplitude, a phase, and a delay of a received signal show rapid change features. The environmental parameter U16 includes a temperature, a humidity, a radiation, and a pressure.

An establishment process of the multi-feature fusion sensing model U2 includes a modeling simulation U21, a ray tracing U22, a time-frequency testing U23, a channel model U24, derivation of a global transfer function U25, a time domain feature U26, an energy domain feature U27, a frequency domain feature U28, and a spatial domain feature U29. From the perspective of multi-feature fusion, deep-level extraction of the time domain feature U26, the energy domain feature U27, the frequency domain feature U28, and the spatial domain feature U29 is realized to reveal internal connections between main feature parameters of RFID in an Internet-of-things environment and establish the multi-feature fusion sensing model U2.

The modeling simulation U21 is intended to model and measure a dynamic scene, define different electromagnetic wave paths in a geometric feature model, configure reasonable physical model parameters for different paths, and construct an equivalent physical model.

The ray tracing U22 considers the effect of direct radiation, refraction, diffraction, scattering, absorption, and polarization on electromagnetic waves, optimizes a wireless sensing path of a radio frequency tag, and performs accuracy analysis on information of each path to a receiving point, and the received signal is represented as:

$$r ( t ) = {\sum }_{i = 1}^{N} {α}_{i} s ( t - {τ}_{i} ) {e}^{j {ϕ}_{i}}$$

where s(t) is an emitted ray signal, αᵢ, τᵢ, and ϕᵢ respectively represent an amplitude, an arrival time, and a phase of an i^{th} ray.

A signal transfer function G(f, d) at the time when an electromagnetic wave is transmitted through various paths is described as:

$$G ( f , d ) = \frac{λ}{4 π {d}_{d d}} exp ( - j k {d}_{d d} ) + \frac{λ}{4 π {d}_{d r}} {C}_{r} exp ( - j k {d}_{d r} ) + {G}_{3} ( f , {d}_{da} ) + {G}_{4} ( f , {d}_{s} )$$

where d_{dd}, d_{dr}, d_{da}, and dₛ are respectively propagation distances of direct radiation, reflection, diffraction, and scattering paths, λ represents a wavelength, k represents a number of paths, Cᵣ represents a reflection coefficient of a surface of the medium, and G₃(f, d_{da}) and G₄(f, dₛ) respectively represent transfer functions of the diffraction and scattering paths.

The time-frequency testing U23 considers time-frequency joint statistical characteristics of an RFID electromagnetic signal, models and measures a dynamic scene, sufficiently considers multiple parameters including propagation characteristics, an antenna type, and an actual scene, analyzes a radiation efficiency, an antenna gain, and a characteristic mode of a tag antenna, and obtains a raw level sample data set of electromagnetic signals by transforming radio frequency data of a bottom-layer polar coordinate system. The channel model U24 derives and improves small-scale fading models such as pure Doppler, Rayleigh, Rician, flat, Nakagami, lognormal, and Suzuki, and meanwhile, considers a complex scattering mechanism and models fading signals superimposed at a receiving end by multipath components of different amplitudes, phases, and delays. Based on assumptions, a mathematical model is used to approximate wireless channel characteristics, and a tag position, a spatial domain direction, a frequency, a bandwidth, and a power parameter are respectively optimized by improved methods.

The global transfer function U25 determines key parameters of a system channel statistical model and a link budget model in an RFID sensing process, optimizes a sensing model modeling method, deduces a global signal transfer function and an energy loss model of electromagnetic waves in a complex Internet-of-things environment, enhances a complex event processing capacity in a multi-context sensing environment, and analyzes in depth internal relevance of RFID sensing impact factors in a complex Internet-of-things scene to establish a link between a physical world and tags.

The multi-feature fusion sensing model U2 effectively applies newly-added sensing information to the environment spatio-temporal changeable adaptive element iteration U4 and forms the Internet-of-things environmental parameter inversion U3.

The Internet-of-things environmental parameter inversion U3 includes a density U31 parameter, a geometry U32 parameter, an attenuation U33 parameter, and a radiation U34 parameter.

The Internet-of-things environmental parameter inversion U3 may be regarded as a nonlinear least squares problem in the following form:

$$min f ( x ) = \frac{1}{2} {s}^{T} ( x ) s ( x ) = \frac{1}{2} {\sum }_{i = 1}^{m} {[ {s}_{i} ( x ) ]}^{2}$$

$$x ∈ {S}^{n} , m \geq n$$

where f(x) represents an objective function, sᵢ(x) is a residual function representing a difference between a radio frequency sensing measurement data and a forward model calculation data, x is an Internet-of-things environmental parameter to be inverted, n is a number of environmental parameters, and m is a number of extracted sensing feature parameters. A diagonal ratio matrix is introduced into density, radiation, attenuation, and geometry parameters in inconsistent units to perform coordinate conversion, so that a singular value decomposition result is irrelevant to units.

The adaptive element iteration U4 derives an error functional between a sensing measured data and a forward simulation data, gives relevant macro statistical performance function and cost function, determines an objective function of an evaluation model, solves a minimization problem of the error functional by iteration using a generalized nonlinear method, inversely deduces a target state parameter to obtain an Internet-of-things environmental parameter component, and forms a closed-loop environmental parameter evaluation. It is determined whether the established model has a standard solution. If not, the model is modified through further abstraction to transform it into a standard model, or a standard model solution is modified.

The adaptive element iteration U4 combines an actual testing and an evaluation result to improve and perfect an extraction method, a theoretical model, and an evaluation method of Internet-of-things environmental sensing parameters, adaptively tracks parameter changes, inspects rationality and practicability of the model, and provides an improved fit between the multi-feature fusion sensing model and the actual situation of the Internet-of-things environment.

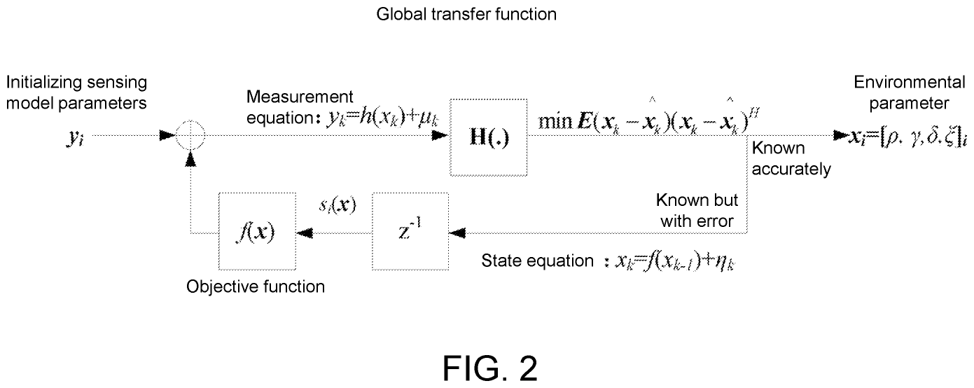

The environmental parameter inversion data model is shown in FIG. 2. After the parameters of the multi-feature fusion sensing model U2 are initialized, by a measurement equation yₖ=h(xₖ)+μₖ and the global transfer function U25, calculation and determination are performed based on a least mean square error estimator min E(xₖ−\hat{x}ₖ)(xₖ−\hat{x}ₖ)^{H} to form an inversion of an Internet-of-things environmental parameter xᵢ=[ρ, γ, δ, ξ]ᵢ, where ρ, γ, δ, and ξ respectively represent the density U31 parameter, the geometry U32 parameter, the attenuation U33 parameter, and the radiation U34 parameter.

When an environmental parameter inversion data model is known but there is an error, the inversion parameter completes one adaptive element iteration U4 through a state equation xₖ=f(xₖ₋₁)+ηₖ, a z transformation, an objective function f(x), and the multi-feature fusion sensing model U2, and combining with the multi-feature fusion sensing model, a measurement data is constantly updated.

In summary of the above, in the adaptive inversion method of Internet-of-things environmental parameters based on the RFID multi-feature fusion sensing model of the disclosure, from the multipath propagation mechanism of electromagnetic waves, the global signal transfer function of RFID sensing is analyzed and derived, the multi-feature fusion sensing model is established, the algebraic relationship between the multi-feature fusion parameters and the experimental result is established by using the existing experimental conditions, the relevant macro statistical performance function and cost function are given, and the newly-added sensing information is applied to the environment spatio-temporal changeable adaptive element iteration to form the Internet-of-things environmental parameter inversion. The disclosure is intended to propose space-medium-interference as an overall concept, sufficiently consider the electromagnetic wave transmission mechanism, combine with the joint characteristics of the generalized time domain, frequency domain, energy domain, and spatial domain, and complete the extraction of the RFID sensing main features. On the basis of theoretical research, combined with actual measurement verification, the establishment of the RFID multi-feature fusion sensing model in a complex Internet-of-things environment is realized. Centered around the complex Internet-of-things environment RFID sensing model, inversions of environmental parameters, complexity levels, and data perturbation of different Internet-of-things scenes are formed. Multipath electromagnetic wave sensing paths are optimized to provide a basis for deployment of

RFID in complex Internet-of-things scenes and efficiently obtain key information such as states and locations to achieve sufficient fusion of “human-machine-things”. Lastly, a new method of environmental Internet-of-things parameter inversion based on a multi-feature fusion sensing model is established.

It will be understood that modifications and variations may be made by persons skilled in the art according to the above description, and all such modifications and variations are intended to be included within the scope of the disclosure as defined in the appended claims.

What is claimed is:

1. An adaptive inversion method of Internet-of-things environmental parameters based on an RFID multi-feature fusion sensing model, the method comprising:
a consensus factor acquisition, which acquires consensus factors in an Internet-of-things environment comprising a spatial geometry, a multipath effect, a medium, an electromagnetic interference, a small-scale fading, and an environmental parameter;
a multi-feature fusion sensing model establishment, which models a multi-feature fusion sensing model for an RFID sensing process by analyzing the consensus factors, comprises a modeling simulation, a ray tracing, a time-frequency testing, and a channel model establishment, and combined with an electromagnetic wave transmission mechanism and multi-feature fusion parameters, derives and obtains a global signal transfer function of electromagnetic waves when transmitted through various paths, wherein the multi-feature fusion parameters comprise a time domain feature, an energy domain feature, a frequency domain feature, and a spatial domain feature;
an Internet-of-things environmental parameter inversion, which applies newly-added RFID sensing information to an environment spatio-temporal changeable adaptive element iteration method to form the Internet-of-things environmental parameter inversion, wherein the Internet-of-things environmental parameters comprise a density parameter, a geometry parameter, an attenuation parameter, and a radiation parameter; and
an adaptive element iteration, which derives an error functional between a sensing measured data and a forward simulation data, gives relevant macro statistical performance function and cost function, determines an objective function of an evaluation model, solves a minimization problem of the error functional by iteration using a generalized nonlinear method, inversely deduces a target state parameter to obtain an Internet-of-things environmental parameter component, and forms a closed-loop environmental parameter evaluation, wherein it is determined whether the established model has a standard solution, and if not, the model is modified through further abstraction to transform it into a standard model, or a standard model solution is modified.

2. The adaptive inversion method of Internet-of-things environmental parameters based on an RFID multi-feature fusion sensing model according to claim 1, wherein the consensus factors in the method specifically comprise:
the spatial geometry, configured to reveal an effect of a spatial location and mobility on path loss;
the multipath effect, comprising direct radiation, refraction, diffraction, and scattering of electromagnetic waves;
the medium, studying an effect of a multi-media environment on a sensing performance of an RFID tag;
the electromagnetic interference, comprising a frequency offset and a mutual coupling effect caused by an external electromagnetic wave interference and dense tags, and extracting multi-source electromagnetic interference parameter features by using actual RFID sensing performance testing data to reduce collision and conflict between internal readers in a large-scale RFID deployment and improve a precision of location sensing;
the small-scale fading, wherein mutual interference of different multipath components of a wireless signal leads to a change in the small-scale fading of an amplitude of a composite signal, and in a short-distance spatial domain or a short-period time domain, instantaneous values in an amplitude, a phase, and a delay of a received signal show rapid change features; and
the environmental parameter, comprising a temperature, a humidity, a radiation, and a pressure.

3. The adaptive inversion method of Internet-of-things environmental parameters based on an RFID multi-feature fusion sensing model according to claim 1, wherein the modeling simulation in the method specifically comprises:
modeling and measuring a dynamic scene, defining different electromagnetic wave paths in a geometric feature model, configuring reasonable physical model parameters for different paths, and constructing an equivalent physical model.

4. The adaptive inversion method of Internet-of-things environmental parameters based on an RFID multi-feature fusion sensing model according to claim 1, wherein the ray tracing in the method specifically comprises:
considering an effect of direct radiation, refraction, diffraction, scattering, absorption, and polarization on electromagnetic waves, optimizing a wireless sensing path of a radio frequency tag, and performing accuracy analysis on information of each path to a receiving point, a received signal being represented as:
$$r ( t ) = {\sum }_{i = 1}^{N} {α}_{i} s ( t - {τ}_{i} ) {e}^{j {ϕ}_{i}}$$
wherein s(t) is an emitted ray signal, αᵢ, τᵢ, and ϕᵢ respectively represent an amplitude, an arrival time, and a phase of an i^{th} ray, and
a signal transfer function G(f, d) at the time when an electromagnetic wave is transmitted through various paths being described as:
$$G ( f , d ) = \frac{λ}{4 π {d}_{d d}} exp ( - j k {d}_{d d} ) + \frac{λ}{4 π {d}_{d r}} {C}_{r} exp ( - j k {d}_{d r} ) + {G}_{3} ( f , {d}_{da} ) + {G}_{4} ( f , {d}_{s} )$$
wherein d_{dd}, d_{dr}, d_{da}, and dₛ are respectively propagation distances of direct radiation, reflection, diffraction, and scattering paths, λ represents a wavelength, k represents a number of paths, Cᵣ represents a reflection coefficient of a surface of a medium, and G₃(f, d_{da}) and G₄(f, dₛ) respectively represent transfer functions of the diffraction and scattering paths.

5. The adaptive inversion method of Internet-of-things environmental parameters based on an RFID multi-feature fusion sensing model according to claim 1, wherein the time-frequency testing in the method specifically comprises:
considering time-frequency joint statistical characteristics of an RFID electromagnetic signal, modeling and measuring a dynamic scene, sufficiently considering multiple parameters comprising propagation characteristics, an antenna type, and an actual scene, analyzing a radiation efficiency, an antenna gain, and a characteristic mode of a tag antenna, and obtaining a raw level sample data set of electromagnetic signals by transforming radio frequency data of a bottom-layer polar coordinate system, wherein the channel model derives and improves small-scale fading models comprising pure Doppler, Rayleigh, Rician, flat, Nakagami, lognormal, and Suzuki, and meanwhile, considers a complex scattering mechanism and models fading signals superimposed at a receiving end by multipath components of different amplitudes, phases, and delays, wherein based on assumptions, a mathematical model is used to approximate wireless channel characteristics, and a tag position, a spatial domain direction, a frequency, a bandwidth, and a power parameter are respectively optimized by improved methods.

6. The adaptive inversion method of Internet-of-things environmental parameters based on an RFID multi-feature fusion sensing model according to claim 1, wherein the global signal transfer function in the method specifically comprises:
determining key parameters of a system channel statistical model and a link budget model in an RFID sensing process, optimizing a sensing model modeling method, deducing a global signal transfer function and an energy loss model of electromagnetic waves in a complex Internet-of-things environment, enhancing a complex event processing capacity in a multi-context sensing environment, and analyzing in depth internal relevance of RFID sensing impact factors in a complex Internet-of-things scene.

7. The adaptive inversion method of Internet-of-things environmental parameters based on an RFID multi-feature fusion sensing model according to claim 1, wherein in the Internet-of-things environmental parameter inversion in the method:
the Internet-of-things environmental parameter inversion comprises a density parameter, a geometry parameter, an attenuation parameter, and a radiation parameter, and the Internet-of-things environmental parameter inversion is regarded as a nonlinear least squares problem in the following form:
$$min f ( x ) = \frac{1}{2} {s}^{T} ( x ) s ( x ) = \frac{1}{2} {\sum }_{i = 1}^{m} {[ {s}_{i} ( x ) ]}^{2}$$
$$x ∈ {S}^{n} , m \geq n$$
wherein f(x) represents an objective function, sᵢ(x) is a residual function representing a difference between a radio frequency sensing measurement data and a forward model calculation data, x is an Internet-of-things environmental parameter to be inverted, n is a number of environmental parameters, and m is a number of extracted sensing feature parameters, and a diagonal ratio matrix is introduced into density, radiation, attenuation, and geometry parameters in inconsistent units to perform coordinate conversion, so that a singular value decomposition result is irrelevant to units.

8. The adaptive inversion method of Internet-of-things environmental parameters based on an RFID multi-feature fusion sensing model according to claim 1, wherein the adaptive element iteration in the method specifically comprises:
combining an actual testing and an evaluation result to improve and perfect an extraction method, a theoretical model, and an evaluation method of Internet-of-things environmental sensing parameters.

9. The adaptive inversion method of Internet-of-things environmental parameters based on an RFID multi-feature fusion sensing model according to claim 8, wherein the adaptive element iteration in the method specifically comprises:
initializing parameters of the multi-feature fusion sensing model, and performing calculation and determination based on a least mean square error estimator min E(xₖ−\hat{x}ₖ)(xₖ−\hat{x}ₖ)^{H} by a measurement equation yₖ=h(xₖ)+μₖ and a global transfer function to form an inversion of an Internet-of-things environmental parameter xᵢ=[ρ, γ, δ, ξ]ᵢ, wherein ρ, γ, δ, and ξ respectively represent the density parameter, the geometry parameter, the attenuation parameter, and the radiation parameter.

10. The adaptive inversion method of Internet-of-things environmental parameters based on an RFID multi-feature fusion sensing model according to claim 9, wherein in the adaptive element iteration in the method:
when an environmental parameter inversion data model is known but there is an error, the inversion parameter completes one adaptive element iteration through a state equation xₖ=f(xₖ₋₁)+ηₖ, a z transformation, an objective function f(x), and the multi-feature fusion sensing model, and combining with the multi-feature fusion sensing model, a measurement data is constantly updated.
